(19) United States
(12) Patent Application Publication
(10) Pub. No.: US 2009/0211055 A1
(43) Pub. Date: Aug. 27, 2009

(54) Door Hinge Stop Mechanism

(76) Inventors: Robert Shinall, Jacksonville, FL (US); Jacqueline Renee Shinall, Jacksonville, FL (US)

Correspondence Address: LAW OFFICE OF L. JACK GIBNEY, 8777 SAN JOSE BLVD., SUITE 502, JACKSONVILLE, FL, 32217, US

(21) Appl. No.: 12/035,821

(22) Filed: Feb. 22, 2008

(51) Int. Cl. E05F 5/02

(52) U.S. Cl. 16/82

(57) ABSTRACT

This invention will permit free movement of a hinge mechanism on a door but will also stop the door at a predetermined point so that there is no damage to a wall or structure behind the door. It will be relatively easy to install and does not alter the shape of the hinge or its operation while at the same time permitting the door to move freely.

### BACKGROUND OF THE INVENTION

A. Field of the Invention

This relates to door hinges, specifically, preventing the movement of a door hinge beyond a certain preset or predetermined point.

B. Prior Art

There are many other prior art references to hinges and hinge mechanisms. Specifically, this device concerns preventing the movement of a hinge beyond a certain preset point. Hinges, of course, are used on a variety of doors.

One side of a hinge is attached to the structure of the building or house and the other supports the door. As the door is opened or closed, one section of the hinge will move and the other will be stationary on the door structure. The current device operates like a standard hinge.

Other prior art references discuss hinges and these include Pieper, II, U.S. Pat. No. 5,881,431, Nikolic, U.S. Pat. No. 6,851,159, Morawetz, U.S. Pat. No. 6,739,020 and Kuntz, U.S. Pat. No. 6,149,212.

The Pieper II reference teaches a door stop that limits the movement of a hinged panel that can be mounted directly to a door stop. As shown on FIG. 9 of the patent the device will limit the movement of the door and is mounted on the hinge of a door. The current device is not mounted on the hinge of a door but slides over the specific hinge that is used with the device.

The Nikolic device is a door hinge for an automobile. While the specific application for a particular device is unimportant, the door stop mechanism is substantially different than the current application.

The Morawetz and Kuntz devices are devices for an automobile with a built in stop and an adjustable door stop mechanism that allows a door to be opened to a desired angle setting.

The current device is a sleeve that fits over an existing hinge. No modifications are made to the hinge or the door and the device can be easily moved without removing the hinge, using special tools or altering the hinge.

### BRIEF SUMMARY OF THE INVENTION

This device is a sleeve that fits over an existing door hinge assembly that will control the movement of a door hinge member to prevent damage to the wall that might be struck by a portion of the door. This is important in that many door hinges will be allowed to rotate freely and frequently a part of the door will strike the structure that is located behind the door.

Hinges are used to support doors in buildings. The doors may be interior doors such as a door leading to an interior room of a house or the door may be an exterior door such as a door that leads outside. One part of the hinge is secured to the actual building structure, usually a door frame, and the other part of the hinge secures the door. In this fashion the door is allowed to rotate so as to provide access into or out of the room or building.

If the movement of the door is allowed to rotate completely the door handle may strike a piece of dry wall, for instance, that has been installed as part of the room wall that forms the structure. Additionally, mirrors are often placed behind door hinges and the door handle may damage a mirror. These occurrences will make it necessary to repair sections of the wall or replace a damaged mirror.

The prevention of this type of damage is particularly important when a door with a significant amount of weight is used, such as a metal door. This device, which is easy to install and allows the door to rotate freely, will prevent the door from moving beyond a certain point and therefore prevent the door from damaging the drywall or mirror that may be placed behind the door.

It will be easy to install, requires no special tools and does not alter the hinge mechanism.

### BRIEF DESCRIPTION OF THE DRAWINGS

FIG. 1 is a view of a door hinge and the device.

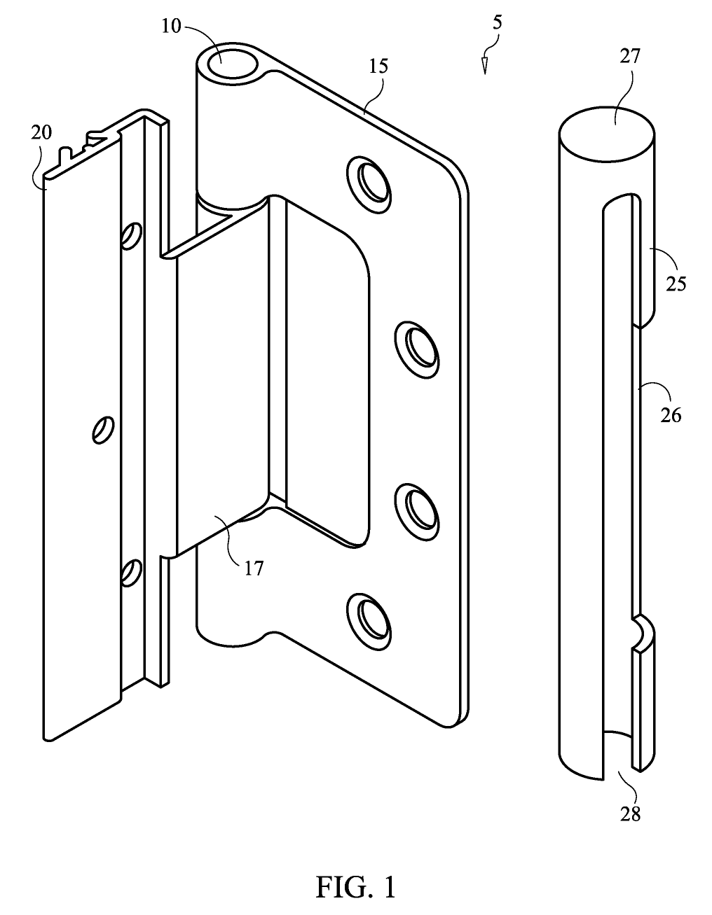

FIG. 2 is an isometric view of the device installed on the door hinge.

FIG. 3 is an isometric view of the device as it is placed over the hinge structure.

FIG. 4 is an isometric view of the device after it has been placed over the hinge structure.

### NUMBERING REFERENCE

5—Device—hinge and sleeve

10—Hinge pin

15—First side of the hinge

17—Connecting piece

20—Second side of the hinge

25—Sleeve

26—Flat indented surface

27—Closed end

28—Open end

30—Sleeve gap

### DETAILED DESCRIPTION OF THE EMBODIMENTS

This device 5, which is comprised of a hinge and a sleeve, prevents the movement of a door hinge beyond a certain preset or predetermined limit. The door hinge, of course, has been used for many years, and it is not new to the prior art.

Door hinges typically have two sides, the first side 15, which is attached to the door structure such as the door frame in the house and the second side 20, which secures the door and is not mounted to the frame of the building. A hinge pin 10 connects the first side to the second side through a set of openings in the first and second side and a connecting piece 17 that is part of the second side. The hinge pin 10 allows the second side 20 to remain connected and rotate. This type of structure is typically found in hinges.

With the hinge installed, the second side of the hinge will be allowed to rotate approximately one hundred eighty degrees, without this device installed. Unfortunately, the door handle, which protrudes from the door, will strike the wall of the structure before the door reaches one hundred eighty degrees. This may cause damage to the wall behind the door with the resultant repair costs.

A cylindrical sleeve 25, which is slightly larger in diameter than the outer casing of the hinge assembly, which houses the hinge pin 10 will fit over the hinge assembly.

One embodiment of the device will be used on a right hand door and another embodiment will be used on a left hand door. The difference between these doors is the way in which the door will open i.e. either to the left or to the right when opening the door from the outside.

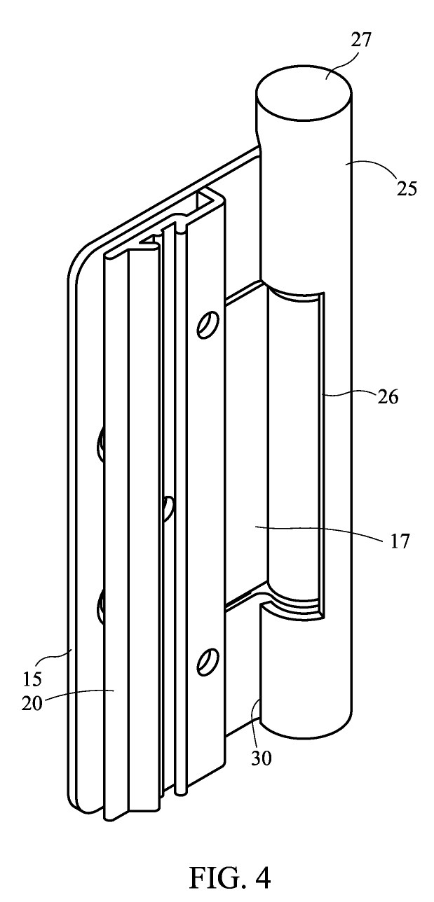

The cylindrical sleeve 25 will have a closed end 27 as well as open end 28 and will be hollow with a cut-out portion so that it will slip over the hinge assembly. Along a predetermined portion of the cut-out portion will be a flat indented portion 26 that will be slightly longer than the connecting piece 17 of the hinge such as depicted in FIG. 4.

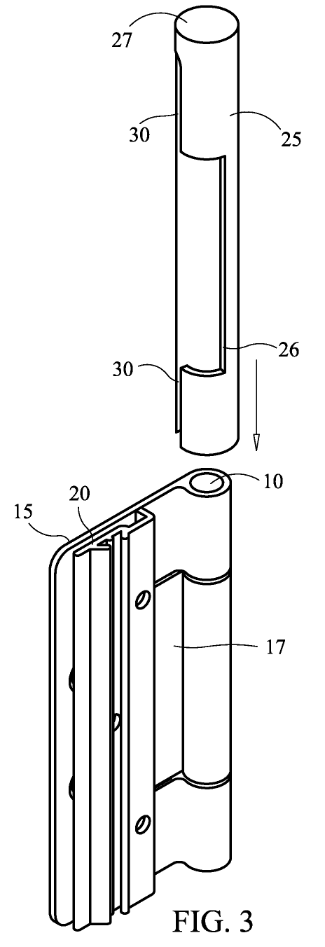

A sleeve gap 30 between the sides of the hollowed portion of the sleeve is provided to enable the sleeve 25 to be placed over the hinge assembly when the first side and second side are flush against each other such as depicted in FIG. 3 prior to installation and as installed such as depicted in FIG. 4. Because one end 27 of the sleeve is closed, the sleeve will remain on the hinge assembly.

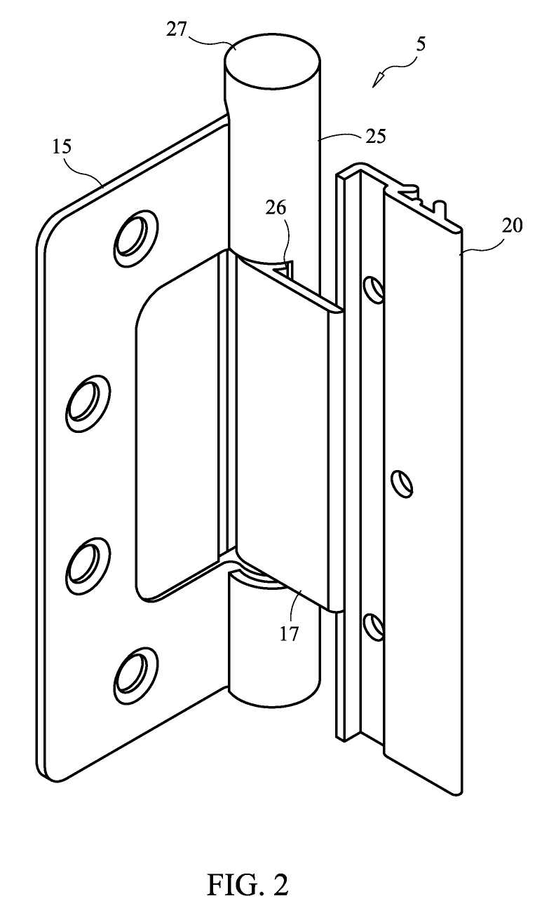

The first side of the hinge 15 is secured to the frame structure and does not move. The door is secured to the second side 20 and is allowed to rotate as the door is opened and closed. The connecting piece 17, which is part of the second side joins the two sides of the hinge. When the device is installed such as depicted in FIG. 2, one side of the connecting piece 17 will strike the flat member of the sleeve 26 and prevent movement of the door beyond a certain predetermined limit thereby preventing damage to the structure of the building.

1. A doorstop hinge mechanism, which is comprised of:
a. a hinge;
wherein the hinge has a first side;
wherein the hinge has a second side;
said first side is attached to the building structure;
said second side secures a door;
b. a hinge pin;
wherein a hinge pin is used to connect the second side to the first side;
c. a connecting piece;
wherein a connecting piece connects the second side of the hinge to the first side of the hinge;
d. a sleeve;
wherein the sleeve has an open end;
wherein the sleeve has a closed end;
wherein the sleeve is a circular hollow structure;
wherein the first end of the sleeve is closed;
wherein the second end of the sleeve is open;
wherein a sleeve gap is provided;
wherein an indented portion of predetermined dimensions is provided in the sleeve;
wherein the sleeve gap is greater than the hinge structure when the first and second sides of the hinge are flush against each other;
wherein the sleeve allows free rotation of the hinge to a predetermined position

2. The device as described in claim 1 wherein the indented portion is longer than the connecting piece.

3. The device as described in claim 1 wherein the device can be used on a right handed door.

4. The device as described in claim 1 wherein the device can be used on a left handed door.
